(19) United States
(12) Patent Application Publication
(10) Pub. No.: US 2010/0270965 A1
(43) Pub. Date: Oct. 28, 2010

(54) Stepping motor control circuit and analog electronic watch

(76) Inventors: Takanori Hasegawa, Chiba-shi (JP); Keishi Honmura, Chiba-shi (JP); Akira Takakura, Chiba-shi (JP); Saburo Manaka, Chiba-shi (JP); Kenji Ogasawara, Chiba-shi (JP); Kazumi Sakumoto, Chiba-shi (JP); Kazuo Kato, Chiba-shi (JP); Kosuke Yamamoto, Chiba-shi (JP)

Correspondence Address: BRUCE L. ADAMS, ESQ;ADAMS & WILKS, 17 BATTERY PLACE - SUITE 1231, NEW YORK, NY, 10004, US

(21) Appl. No.: 12/799,233

(22) Filed: Apr. 21, 2010

(30) Foreign Application Priority Data
Apr. 23, 2009 (JP) 2009-105558

(51) Int. Cl. H02P 8/38; G04B 19/04

(52) U.S. Cl. 318/696; 368/80

(57) ABSTRACT

A stepping motor control circuit includes a rotation detecting means for detecting an induced signal generated by rotation of a rotor of a stepping motor, and detecting a rotation state of the stepping motor according to whether the induced signal exceeds a predetermined reference threshold voltage in a predetermined detection section, and a control means for controlling driving of the stepping motor by using any one of a plurality of main driving pulses having energy different from each other or a correction driving pulse having energy higher than energy of each main driving pulse according to a detection result of the rotation detecting means. The detection section is divided into a first section immediately after driving with the main driving pulse, a second section after the first section, a third section after the second section, and a fourth section after the third section, and the control means lengthens at least one of the first and second sections when the rotation detecting means has detected an induced signal exceeding the reference threshold voltage in the second section.

### BACKGROUND OF THE INVENTION

1. Field of the Invention

The present invention relates to a stepping motor control circuit and an analog electronic watch using the same.

2. Background Art

In the related art, a stepping motor is used for an analog electronic watch and the like. The stepping motor includes a stator provided with a rotor receiving hole and a position determining portion for determining a stop position of a rotor, the rotor provided in the rotor receiving hole, and a coil. Further, the stepping motor rotates the rotor by magnetic flux generated in the stator by an alternating signal supplied to the coil, and stops the rotor at a position corresponding to the position determining portion.

As a control scheme for the stepping motor, there has been used a correction driving scheme in which, when the stepping motor is driven by a main driving pulse, it is detected whether the stepping motor is rotated by detecting an induced signal generated by free vibration after rotation of the stepping motor, and the main driving pulse is changed to a main driving pulse having a different pulse width for the driving of the stepping motor according to the detection result, or the stepping motor is forcibly rotated by a correction driving pulse having a pulse width wider than that of a main driving pulse (for example, refer to JP-B-61-15385).

Further, in WO2005/119377, when detecting the rotation of the stepping motor, a means for comparing a detection time with a reference time is provided in addition to the detection of the induced signal, after the stepping motor is rotated by a main driving pulse P11, a correction driving pulse P2 is output if an induced signal is less than a predetermined reference threshold voltage Vcomp, and a next main driving pulse P1 is changed to a main driving pulse P12 with energy higher than that of the main driving pulse P11 so that the stepping motor is driven by the main driving pulse P12. If the detection time when the stepping motor has been rotated by the main driving pulse P12 is earlier than the reference time, the main driving pulse P12 is changed to the main driving pulse P11, so that the stepping motor is rotated by the main driving pulse P1 according to a load during the driving thereof, resulting in reduction of current consumption.

However, a peak generation time of an induced signal generated by the free vibration of the rotor is advanced when driving energy is high as compared with a load but it is delayed when the driving energy is low as compared with the load. Further, due to the influence of variation of a train wheel load, variation of a peak voltage may be large according to the passage of time. Furthermore, since variation of a load occurs due to individual movements, it is difficult to perform stable driving pulse control based on the peak generation time of the induced signal.

### SUMMARY OF THE INVENTION

It is an aspect of the present invention to perform driving control based on an appropriate driving pulse by exactly determining an extra driving force.

According to the aspect of the invention, a stepping motor control circuit includes: a rotation detecting means for detecting an induced signal generated by rotation of a rotor of a stepping motor, and detecting a rotation state of the stepping motor according to whether the induced signal exceeds a predetermined reference threshold voltage in a predetermined detection section; and a control means for controlling driving of the stepping motor by using any one of a plurality of main driving pulses having energy different from each other or a correction driving pulse having energy higher than energy of each main driving pulse according to a detection result of the rotation detecting means, wherein the detection section is divided into a first section immediately after driving with the main driving pulse, a second section after the first section, a third section after the second section, and a fourth section after the third section, and the control means lengthens at least one of the first and second sections when the rotation detecting means has detected an induced signal exceeding the reference threshold voltage in the second section.

The detection section is divided into the first section immediately after the driving with the main driving pulse, the second section after the first section, the third section after the second section, and the fourth section after the third section, and the control means lengthens at least one of the first and second sections when the rotation detecting means has detected the induced signal exceeding the reference threshold voltage in the second section.

Herein, when the rotation detecting means has detected the induced signal exceeding the reference threshold voltage in the second section, the control means may be configured to lengthen at least one of the first and second sections during the next and subsequent driving.

Further, when the rotation detecting means has detected the induced signal exceeding the reference, threshold voltage in the second section and the at least one of the first and second sections is lengthened, the control means may be configured to shorten the third section.

Furthermore, after the rotation detecting means has detected the induced signal exceeding the reference threshold voltage in the second section and the length of a section is changed, when the rotation detecting means has not detected the induced signal exceeding the reference threshold voltage in the second section, the control means may be configured to allow the section with the changed length to have an original length.

In addition, according to the present invention, there is provided an analog electronic watch including: a stepping motor for rotating time hands; and a stepping motor control circuit for controlling the stepping motor, wherein the above-described stepping motor control circuit is used as the stepping motor control circuit.

According to the stepping motor control circuit of the present invention, driving control based on an appropriate driving pulse can be performed by exactly determining an extra driving force. Further, since efficient correction driving pulse control is possible, low power consumption can be achieved.

In addition, according to the analog electronic watch of the present invention, since the driving control based on the appropriate driving pulse can be performed by exactly determining the extra driving force, a time counting operation can be exactly performed and low power consumption can be achieved.

### BRIEF DESCRIPTION OF THE DRAWINGS

FIG. 1 is a block diagram illustrating an analog electronic watch according to an embodiment of the invention;

FIG. 2 is a diagram illustrating the configuration of a stepping motor used for an analog electronic watch according to an embodiment of the invention;

FIGS. 3A to 3G are timing diagrams illustrating the operations of a stepping motor control circuit and an analog electronic watch according to an embodiment of the invention; and

FIG. 4 is a determination chart illustrating the operations of a stepping motor control circuit and an analog electronic watch according to an embodiment of the invention.

### DETAILED DESCRIPTION OF THE INVENTION

Hereinafter, a motor control circuit and an analog electronic watch according to an embodiment of the present invention will be described with reference to the accompanying drawings. Further, in the drawings, the same reference numerals are used to designate the same elements in order to avoid redundancy.

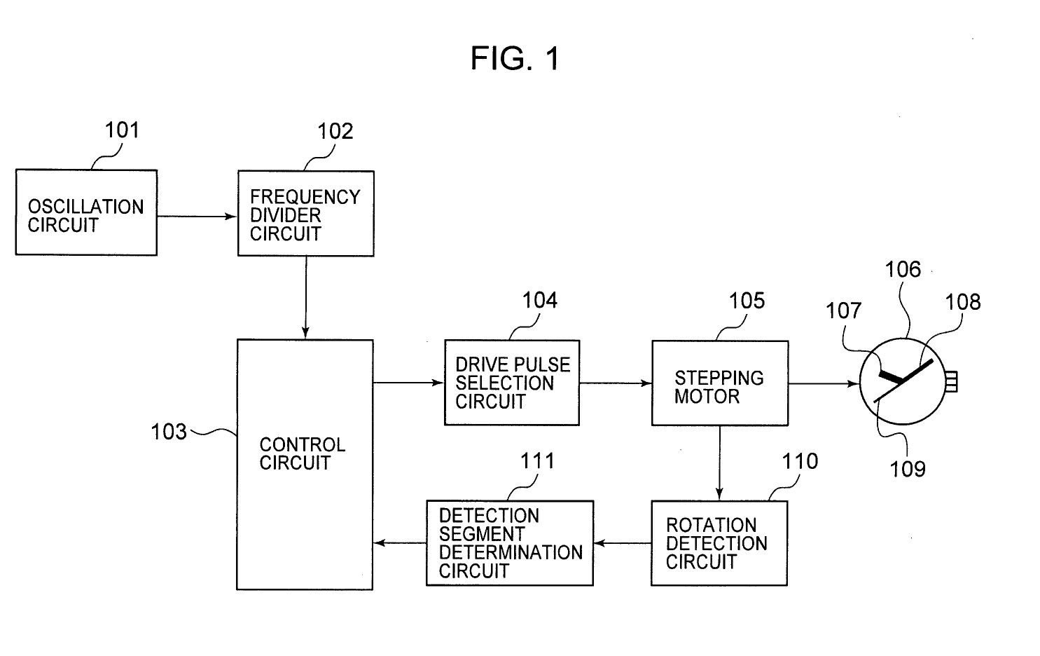

FIG. 1 is a block diagram illustrating an analog electronic watch using the motor control circuit according to the embodiment of the present invention, which illustrates the example of an analog electronic wrist watch.

The outline of the present embodiment will be described. A detection section T for detecting rotation of a stepping motor is divided into four sections arranged in sequence of a first section T1a immediately after driving with a main driving pulse P1, a second section T1b, a third section T2, and a fourth section T3.

In a normal load state, the first section T1a serves as a section for detecting a rotation state of a rotor in the forward direction in a third quadrant of an XY coordinate space employing the rotor of the stepping motor as the center, the second section T1b serves as a section for detecting the rotation state of the rotor in the forward direction and the initial rotation state of the rotor in the backward direction in the third quadrant, the third section T2 serves as a section for detecting the initial rotation state of the rotor in the backward direction in the third quadrant, and the fourth section T3 serves as a section for detecting the rotation state of the rotor after the initial rotation of the rotor in the backward direction in the third quadrant.

When driving energy of the main driving pulse P1 is normal, since a rotor rotation angle after main driving pulse interruption exceeds a second quadrant II, an induced signal VRs, which is generated by free vibration after the rotation of the stepping motor and exceeds a predetermined reference threshold voltage Vcomp, does not appear in the first section T1a and the second section T1b and appears after the third section T2.

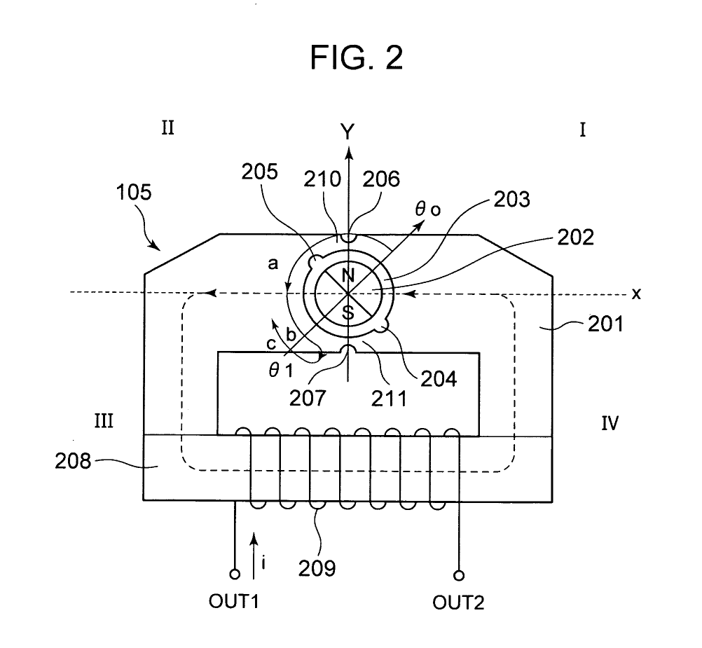

Further, when the rotor does not have enough power to rotate, rotation vibration of the rotor after the main driving pulse interruption appears in an area (an area “a” of FIG. 2) of the second quadrant II and the induced signal VRs appears in the first section T1a and the second section T1b, thereby representing that extra rotation power is reduced.

Based on such characteristics, driving control with an appropriate driving pulse is performed by exactly determining an extra driving force. According to the present embodiment, when the induced signal VRs exceeds the predetermined reference threshold voltage Vcomp in the fourth section T3 (in the case of “1”), the rotation state of the rotor is determined as slight rotation and the rank of the main driving pulse P1 is allowed to be up by one rank without outputting driving with a correction driving pulse P2. In this way, since the driving with a correction driving pulse P2 is not performed and efficient correction driving pulse control is possible, low power consumption can be achieved.

Further, according to the present embodiment, the rotation state of the rotor can be detected using a peak of an induced signal in the detection sections of the first section T1a and the second section T1b, and it is possible to determine maintenance of a pulse with the same driving energy or change to a pulse with small energy.

For example, it is possible to perform a change to a driving pulse with energy changed based on a result obtained by comparing the induced signal VRs with the reference threshold voltage Vcomp. In detail, when the induced signal VRs of the first section T1a exceeds the reference threshold voltage Vcomp and the induced signal VRs of the third section T2 exceeds the reference threshold voltage Vcomp, the main driving pulse P1 is not changed and the main driving pulse P1 with the same energy is maintained.

In this way, normal driving, the rotation state of the rotor in which a driving force is slightly reduced, the rotation state in which the rotor does not have enough power to rotate and the like can be distinguished from each other, and erroneous determination can be prevented by exactly determining the rotation of the rotor. Further, behavior of the rotor up to just before the rotor is in a non-rotation state can be detected using an induced voltage and it is possible to control efficient correction driving output, so that low power consumption can be achieved.

In addition, according to the present embodiment, when the induced signal VRs exceeding the reference threshold voltage Vcomp has been detected in the second section T1b, at least one of the first section T1a and the second section T1b is lengthened, so that driving control with an appropriate driving pulse can be performed by exactly determining an extra driving force. Consequently, efficient correction driving pulse control is possible, so that low power consumption can be achieved.

Hereinafter, the embodiment of the present invention will be described in detail.

In FIG. 1, the analog electronic watch includes an oscillating circuit 101, a divider circuit 102, a control circuit 103, a driving pulse selecting circuit 104, a stepping motor 105, an analog display unit 106, a rotation detecting circuit 110 and a detection time determining circuit 111. The oscillating circuit 101 generates a signal with a predetermined frequency. The divider circuit 102 divides the signal generated by the oscillating circuit 101 to generate a watch signal serving as a reference of a watch. The control circuit 103 controls electronic circuit elements constituting the electronic watch or controls the change of a driving pulse. The driving pulse selecting circuit 104 selects a driving pulse for motor rotation driving based on a control signal from the control circuit 103 and outputs the selected driving pulse. The stepping motor 105 is rotated by the driving pulse from the driving pulse selecting circuit 104. The analog display unit 106 has three types of time hands (in the example of FIG. 1, an hour hand 107, a minute hand 108 and a second-hand 109) rotated by the stepping motor 105 to display a time. The rotation detecting circuit 110 detects an induced signal, which represents the rotation state of the stepping motor 105, in a predetermined detection section. The detection time determining circuit 111 compares the time, at which the rotation detecting circuit 110 has detected the induced signal exceeding the predetermined reference threshold voltage Vcomp, with a section in which the induced signal has been detected, and determines a detection section of the induced signal. Herein, the detection section for detecting the rotation state of the stepping motor 105 is divided into four sections.

The rotation detecting circuit 110 has the same configuration as that of the rotation detection circuit according to JP-B-61-15385 and determines the level of the induced signal which is generated by free vibration after the rotation of the stepping motor 105. The reference threshold voltage Vcomp is set such that determination of rotation and non-rotation or control for driving pulse change can be performed based on a combination of detection sections of an induced signal exceeding a predetermined level.

Further, the oscillating circuit 101 and the divider circuit 102 constitute a signal generating means, and the analog display unit 106 constitutes a time display means. The rotation detecting circuit 110 constitutes a rotation detecting means, and the control circuit 103, the driving pulse selecting circuit 104, the rotation detecting circuit 110 and the detection time determining circuit 111 constitute a control means.

FIG. 2 is a diagram illustrating the configuration of the stepping motor 105 used for the embodiment of the present invention, which illustrates an example of a watch stepping motor generally used for an analog electronic watch.

In FIG. 2, the stepping motor 105 includes a stator 201 formed with a rotor receiving through hole 203, a rotor 202 rotatably provided in the rotor receiving through hole 203, a magnetic core 208 bonded to the stator 201, and a coil 209 wound around the magnetic core 208. When the stepping motor 105 is used for an analog electronic watch, the stator 201 and the magnetic core 208 are fixed to a ground plane (not shown) by screws (not shown) while being bonded to each other. The coil 209 has a primary terminal OUT1 and a secondary terminal OUT2.

The rotor 202 is magnetized to two poles (S and N poles). The stator 201 made of a magnetic material is formed at the outer end portion thereof with a plurality (two in the present embodiment) of cutout parts (outer notches) 206 and 207 which face each other while interposing the rotor receiving through hole 203 therebetween. Saturable parts 210 and 211 are provided between each of the notches 206 and 207 and the rotor receiving through hole 203.

The saturable parts 210 and 211 are not saturated by the magnetic flux of the rotor 202, but are saturated when the coil 209 is excited so that magnetic resistance becomes large. The rotor receiving through hole 203 is formed in circular hole shape in which a plurality (two in the present embodiment) of semilunar cutout parts (inner notches) 204 and 205 are integrally formed with each other at opposite positions of the through hole which is circular in outline.

The cutout parts 204 and 205 serve as position determining portions for determining a stop position of the rotor 202. In the state in which the coil 209 is not excited, the rotor 202 is stably stopped at a position corresponding to the position determining portions as illustrated in FIG. 2, in other words, a magnetic pole axis of the rotor 202 is stably stopped at a position (position of an angle of θ0) which is perpendicular to a line segment which connects the cutout part 204 to the cutout part 205. An XY coordinate space, in which a rotation axis (rotation center) of the rotor 202 is employed as a center, is divided into four quadrants (first to fourth quadrants I to IV).

If an electric current i flows in the arrow direction of FIG. 2 by a rectangular waveform driving pulse supplied between the terminals OUT1 and OUT2 of the coil 209 from the driving pulse selecting circuit 104 (e.g., the primary terminal OUT1 is referred to as a positive pole and the secondary terminal OUT2 is referred to as a negative pole), magnetic flux is generated in the stator 201 in the broken line arrow direction. Therefore, the saturable parts 210 and 211 are saturated so that magnetic resistance becomes large. Thereafter, due to an interaction between magnetic poles generated in the stator 201 and the magnetic poles of the rotor 202, since the rotor 202 is rotated at an angle of 180° in the forward direction (counterclockwise direction of FIG. 2), the magnetic pole axis of the rotor 202 is stably stopped at a position of an angle of θ1. Herein, the rotation direction, in which a normal operation (a hand moving operation in the electronic watch of the present embodiment) is performed by the rotation of the stepping motor 105, will be referred to as the forward direction, and the opposite will be referred to as the backward direction.

Next, if an electric current flows in the opposite arrow direction of FIG. 2 by a rectangular waveform driving pulse having a reverse polarity supplied between the terminals OUT1 and OUT2 of the coil 209 from the driving pulse selecting circuit 104 (the primary terminal OUT1 is referred to as a negative pole and the secondary terminal OUT2 is referred to as a positive pole such that reverse polarity occurs as compared with the above driving), magnetic flux is generated in the stator 201 in the direction opposite to the broken line arrow direction. Therefore, the saturable parts 210 and 211 are first saturated. Thereafter, due to the interaction between the magnetic poles generated in the stator 201 and the magnetic poles of the rotor 202, since the rotor 202 is rotated at the angle of 180° in the same direction (forward direction) as that in the above case, the magnetic pole axis of the rotor 202 is stably stopped at a position of the angle of θ0.

Then, the above operation is repeated by supplying the coil 209 with signals (alternating signals) having different polarities, so that the rotor 202 can be continuously rotated by 180° in the arrow direction. According to the present embodiment, as described later, a plurality of main driving pulses P10 to P1m having different energy and a correction driving pulse P2 are used as the driving pulse.

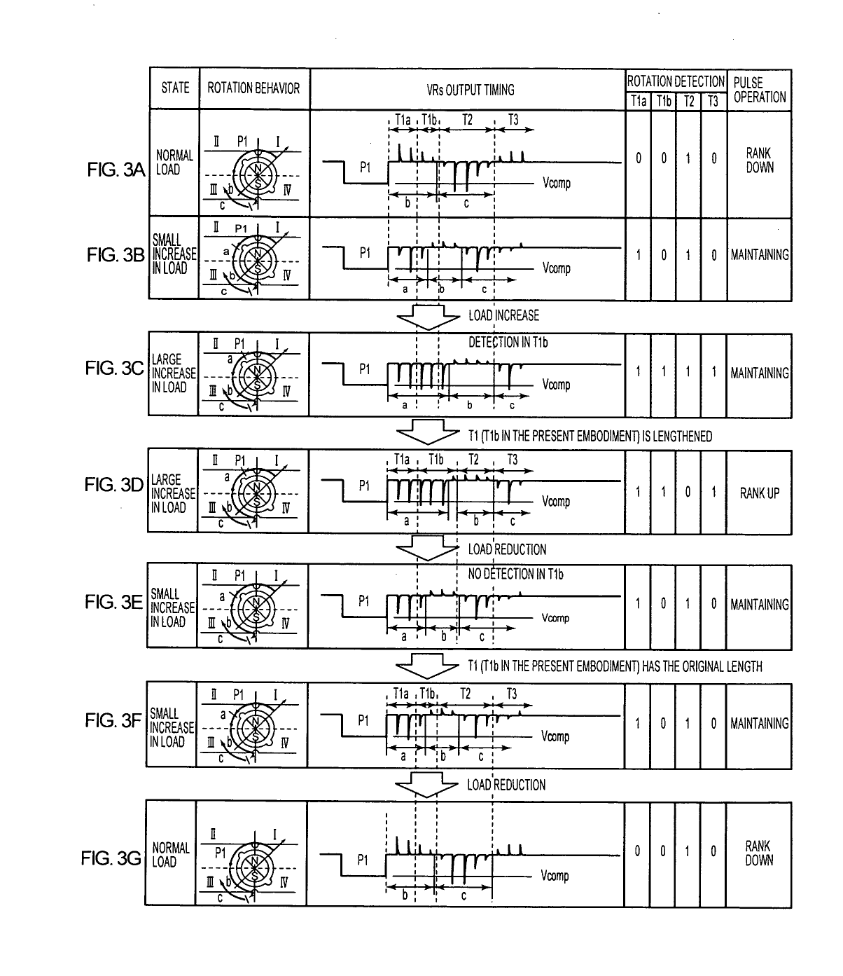

FIGS. 3A to 3G are timing diagrams when the stepping motor 105 is driven by the main driving pulse P1 according to the present embodiment, which collectively illustrates the magnitude of a load and the rotation position of the rotor 202.

In FIGS. 3A to 3G, P1 denotes a section in which the rotor 202 is rotated by the main driving pulse P1, and “a” to “c” denote sections representing rotation areas of the rotor 202 due to free vibration after driving of the main driving pulse P1 is stopped.

A predetermined time immediately after driving with the main driving pulse P1 is defined as a first section T1a, a predetermined time after the first section T1a is defined as a second section T1b, a predetermined time after the second section is defined as a third section T2, and a predetermined time after the third section T2 is defined as a fourth section T3. In this way, the entire detection section T starting from immediately after the driving with the main driving pulse P1 is divided into a plurality of sections (in the present embodiment, four sections T1a, T1b, T2 and T3). However, in the present embodiment, a mask section, which is a period in which the induced signal is not detected, is not provided.

When the rotor 202 is employed as the center and a space area, in which the main magnetic pole of the rotor 202 is located by the rotation thereof, is divided into first to fourth quadrants I to IV, the first to fourth sections T1a, T1b, T2 and T3 can be defined as follows.

That is, in a state of a load (normal load) in which the load is normally driven, the first section T1a serves as a section for detecting the rotation state of the rotor 202 in the forward direction (counterclockwise direction) in the third quadrant III, the second section T1b serves as a section for detecting the rotation state of the rotor 202 in the forward direction and the initial rotation state of the rotor 202 in the backward direction (clockwise direction) in the third quadrant III, the third section T2 serves as a section for detecting the initial rotation state of the rotor 202 in the backward direction in the third quadrant III, and the fourth section T3 serves as a section for detecting the rotation state of the rotor 202 after the initial rotation of the rotor 202 in the backward direction in the third quadrant III.

Further, in a state in which a small load is added to the normal load (i.e., increase in a load is small), the first section T1a serves as a section for detecting the rotation state of the rotor 202 in the second quadrant II, the second section T1b serves as a section for detecting the rotation state of the rotor 202 in the second quadrant II and the initial rotation state of the rotor 202 in the forward direction in the third quadrant III, the third section T2 serves as a section for detecting the initial rotation state of the rotor 202 in the forward direction and the initial rotation state of the rotor 202 in the backward direction in the third quadrant III, and the fourth section T3 serves as a section for detecting the rotation state of the rotor 202 after the initial rotation of the rotor 202 in the backward direction in the third quadrant III.

The Vcomp serves as a reference threshold voltage for determining a voltage level of the induced signal VRs generated in the stepping motor 105. When the rotor 202 has performed a predetermined operation with a heavy load such as a case in which the stepping motor 105 has rotated, the reference threshold voltage Vcomp is set such that the induced signal VRs exceeds the reference threshold voltage Vcomp. However, when the rotor 202 does not perform the predetermined operation with the heavy load such as a case in which the stepping motor 105 does not rotate, the reference threshold voltage Vcomp is set such that the induced signal VRs does not exceed the reference threshold voltage Vcomp.

For example, referring to FIGS. 3A to 3G, according to the stepping motor control circuit of the present embodiment, in the state in which the increase in the load is small, an induced signal VRs generated in the area “a” is detected in the first section T1a, an induced signal generated in the area “c” is detected in the third section T2 and the fourth section T3, and an induced signal generated in the area “b” is detected in the second section T1b and the third section T2.

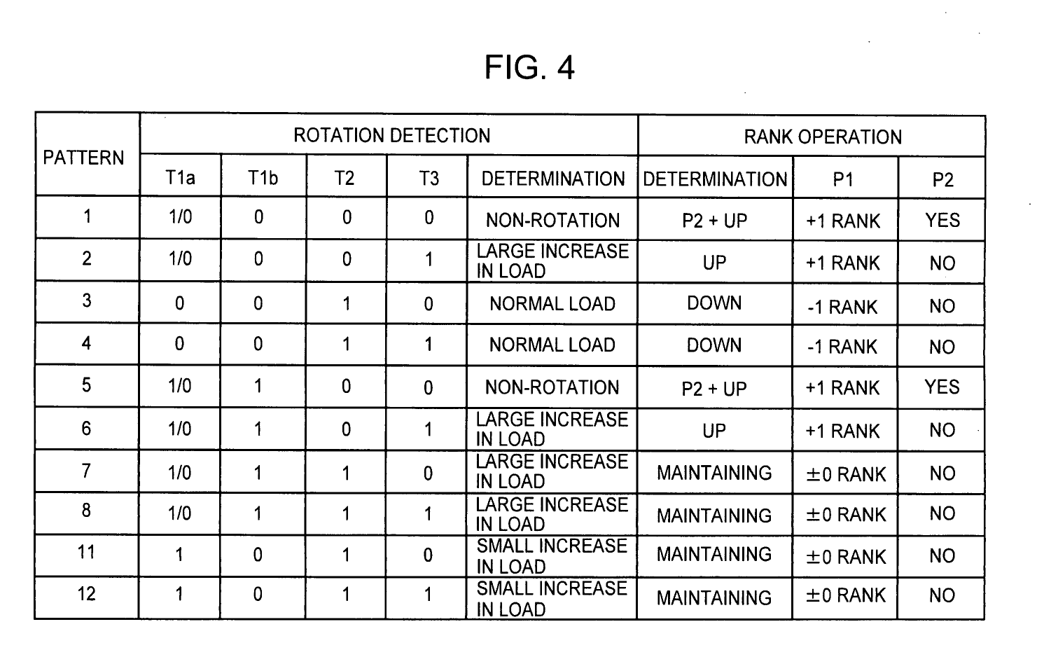

FIG. 4 is a determination chart obtained by collecting operations according to the present embodiment. In FIG. 4, a determination value “1” is given when the rotation detecting circuit 110 has detected the induced signal VRs exceeding the reference threshold voltage Vcomp, and a determination value “0” is given when the rotation detecting circuit 110 cannot detect the induced signal VRs exceeding the reference threshold voltage Vcomp. Further, “1/0” represents that the determination value may have “1” or “0”.

As illustrated in FIG. 4, the rotation detecting circuit 110 detects the existence of the induced signal VRs exceeding the reference threshold voltage Vcomp. The control circuit 103 and the driving pulse selecting circuit 104 are based on a determination pattern (a determination value of the first section T1a, a determination value of the second section T1b, a determination value of the third section T2 and a determination value of the fourth section T3) of the detection time determining circuit 111 for the detection time of the induced signal, and perform driving pulse control such as pulse up or pulse down of the main driving pulse P1 or driving with the correction driving pulse with reference to the determination chart of FIG. 4 which is stored in the control circuit 103, thereby controlling the rotation of the stepping motor 105.

For example, in the case of pattern 1 (1/0, 0, 0, 0) and pattern 5 (1/0, 1, 0, 0), after determining that the stepping motor does not rotate and controlling the driving pulse selecting circuit 104 such that the stepping motor 105 is driven by the correction driving pulse P2, the control circuit 103 controls the driving pulse selecting circuit 104 such that a change to the main driving pulse P1 after one rank up is performed in the next driving for the stepping motor 105.

In the case of pattern 2 (1/0, 0, 0, 1) and pattern 6 (1/0, 1, 0, 1), after determining that the stepping motor has rotated but a heavy load is added to a normal load (increase in a load is large) so that non-rotation may be caused in the next driving, the control circuit 103 does not perform driving with the correction driving pulse P2 and controls the driving pulse selecting circuit 104 in advance such that the change to the main driving pulse P1 after one rank up is performed in the next driving for the stepping motor 105.

In the case of pattern 3 (0, 0, 1, 0) (FIG. 3A) and pattern 4 (0, 0, 1, 1), after determining that the stepping motor has rotated, a load is a normal load and driving energy is left, the control circuit 103 controls the driving pulse selecting circuit 104 such that the change to the main driving pulse P1 after one rank down is performed in the next driving for the stepping motor 105.

In the case of pattern 11 (1, 0, 1, 0) (FIG. 3B) and pattern 12 (1, 0, 1, 1), after determining that the stepping motor has rotated, and the increase in the load is small and driving energy is appropriate, the control circuit 103 controls the driving pulse selecting circuit 104 such that the stepping motor 105 is driven without changing the main driving pulse P1 in the next driving.

Meanwhile, the present invention may have a configuration in which the detection section is divided into three sections (e.g., a first section T1 obtained by combining the first section T1a with the second section T1b of the present embodiment, a second section T2 and a third section T3), and a control method (the energy of the main driving pulse P1 is maintained without any change when the determination value of the first section is “1”, the main driving pulse P1 is subject to pulse down for a constant period when the first section has a value of “0” and the second or third section has a value of “1”, and the main driving pulse P1 is subject to pulse up when the third section has a value of “1”) is used to change the energy of the main driving pulse P1 according to detection patterns in these sections. That is, when the first section has a value of “1”, the rank of the main driving pulse is maintained to prevent the occurrence of non-rotation caused by unnecessary pulse down. When the third section has a value of “1”, the main driving pulse P1 is quickly subject to the pulse up to prevent the occurrence of the non-rotation. In addition, when the first section has a value of “0” and the second or third section has a value of “1”, the pulse down is enabled to suppress power consumption.

However, referring to FIG. 2, when the rotation speed of the rotor is reduced by supply voltage drop, increase in the viscosity of oil at the low temperature, a calendar load and the like, the induced signal VRs, which is generated by the rotation (area “a”) of the rotor in the forward direction in the second quadrant II, is generated after being delayed, so that “1” may be detected in the second section as well as the first section. At this time, referring to FIG. 2, although the induced signal VRs, which is generated by the rotation (area “c”) of the rotor in the backward direction in the third quadrant III, appears in the third section, since “1” is detected in the first section and the second section, it is erroneously determined that the rank of the main driving pulse P1 is maintained without any change. Thus, even if the rank of the main driving pulse P1 is to be up under ordinary circumstances, the main driving pulse P1 cannot be subject to rank up and non-rotation may be caused.

According to the embodiment of the present invention, the first section is divided into two sections so that the detection section is divided into the four sections including the first section T1a, the second section T1b, the third section T2 and the fourth section T3, and, when the rotation detecting circuit 110 has detected the induced signal VRs exceeding the reference threshold voltage Vcomp in the second section T1b during the rotation detection, at least one length of the first section T1a and the second section T1b is changed.

As a method of changing at least one length of the first section T1a and the second section T1b, for example, both the length of the first section T1a and the length of the second section T1b may be lengthened, or at least one of the first section T1a and the second section T1b may be lengthened. When at least one of the first section T1a and the second section T1b is lengthened, the length of the third section T2 may be shortened such that the total length of the detection section T and the length of the fourth section are not changed. Further, in the case of changing the length of the section as described above, when “1” is detected in the second section T1b, the section change may be immediately performed to change the length of the section in a corresponding driving pulse or change the length of the section from a next driving pulse.

According to the present embodiment, when “1” is detected in the second section T1b, the second section T1b is lengthened and the third section T2 is shortened without delay in the driving pulse P1, so that the total length of the detection section T and the length of the fourth section are not changed.

In addition, after at least one of the first section T1a and the second section T1b is lengthened, when “1” is not detected in the second section T1b, the section with the changed length is allowed to have an original length in the next driving.

Consequently, it is possible to minimize the probability in which rank maintenance is determined when the induced signal VRs of “1”, which is to be generated in the first section T1a or the second section T1b, is generated after being delayed by supply voltage drop or load increase and detected in the third section T2, so that the non-rotation may be caused without performing the rank up, and hand movement and the like is delayed.

Hereinafter, the above operation will be described with reference to FIG. 4. In the case of pattern 5 (1/0, 1, 0, 0) and pattern 6 (1/0, 1, 0, 1), since the rotation detecting circuit 110 detects the induced signal VRs exceeding the reference threshold voltage Vcomp in the second section T1b, the control circuit 103 controls the detection time determining circuit 111 to lengthen the length of the second section T1b and to shorten the length of the third section T2 such that the length of the fourth section and the total length of the detection section T are not changed. Consequently, it is possible to minimize the probability in which the rank maintenance is determined when the induced signal VRs of “1”, which is to be generated in the first section T1a or the second section T1b, is generated after being delayed by supply voltage drop or load increase and detected in the third section T2, so that the non-rotation may be caused without performing the rank up, and the hand movement and the like is delayed.

FIG. 4 illustrates pattern 7 (1/0, 1, 1, 0) and pattern 8 (1/0, 1, 1, 1) as an example. However, when the second section T1b is lengthened immediately after “1” is detected in the second section T1b as in the case of the present embodiment, the patterns 7 and 8 are not generated.

For example, when a load is increased from the state of FIG. 3B, the pattern 6 is to be detected under ordinary circumstances. However, as illustrated in FIG. 3C, a case may occur in which “1” is detected in the third section T2 and the pattern 8 may be detected. In such a case, the rank of the main driving pulse P1 is to be up under ordinary circumstances because “1” is detected in the fourth section T3, but the rank maintenance may be determined.

However, according to the present embodiment, since the second section T1b is lengthened immediately after “1” is detected in the second section T1b, the detection result of the third section T2 is “0”, the pattern 6 is determined as illustrated in FIG. 3D and the rank up can be normally performed.

After the second section T1b is lengthened, when “1” is not detected in the second section T1b due to the reduction of a load and the like (FIG. 3E), the control circuit 103 controls the detection time determining circuit 111 such that the section (e.g., the second section T1b) with the changed length has an original length (FIG. 3F). Consequently, detection of normal rank maintenance is possible. When a normal load state is reached from the above state due to additional reduction of the load, as illustrated in FIG. 3G, since the second section T1b has the original length, the induced signal VRs caused by rotation in the backward direction (area “c”) is not detected in the second section T1b and is detected in the third section T2. Thus, the rank of the main driving pulse P1 can be normally down.

As described above, according to the stepping motor control circuit of the embodiment of the present invention, when the rotation detecting circuit 110 has detected the induced signal VRs exceeding the reference threshold voltage Vcomp in the second section T1b, the control circuit 103 controls the detection time determining circuit 111 such that at least one of the first section T1a and the second section T1b is lengthened and the rotation detecting operation is performed. Consequently, driving control with an appropriate driving pulse is performed by exactly determining an extra driving force.

In addition, according to the analog electronic watch of another embodiment of the present invention, the driving control with the appropriate driving pulse is performed by exactly determining the extra driving force, so that a time counting operation can be exactly performed and low power consumption can be achieved.

Further, in the embodiment, since the energy of each main driving pulse P1 is changed, the pulse widths are allowed to be different from each other. However, the driving energy can be changed by changing a pulse voltage. Furthermore, after the main driving pulse P1 is allowed to have a chopping waveform of a comb-tooth shape, the number of chopping or a duty ratio is allowed to be changed, so that the driving energy of the main driving pulse P1 may be changed.

Furthermore, the present invention can be applied to a stepping motor for driving a calendar and the like, in addition to time hands.

In addition, the electronic watch has been described as an application of a stepping motor. However, the invention can be applied to an electronic apparatus using a motor.

The stepping motor control circuit according to the invention can be applied to various electronic apparatuses using a stepping motor.

Moreover, the electronic watch according to the invention can be applied to various analog electronic watches including an analog electronic wrist watch having a calendar function, and an analog electronic watch having various calendar functions such as an analog electronic table clock having a calendar function.

What is claimed is:

1. A stepping motor control circuit comprising:
a rotation detecting means for detecting an induced signal generated by rotation of a rotor of a stepping motor, and detecting a rotation state of the stepping motor according to whether the induced signal exceeds a predetermined reference threshold voltage in a predetermined detection section; and
a control means for controlling driving of the stepping motor by using any one of a plurality of main driving pulses having energy different from each other or a correction driving pulse having energy higher than energy of each main driving pulse according to a detection result of the rotation detecting means,
wherein the detection section is divided into a first section immediately after driving with the main driving pulse, a second section after the first section, a third section after the second section, and a fourth section after the third section, and
the control means lengthens at least one of the first and second sections when the rotation detecting means has detected an induced signal exceeding the reference threshold voltage in the second section.

2. The stepping motor control circuit according to claim 1, wherein, when the rotation detecting means has detected an induced signal exceeding the reference threshold voltage in the second section, the control means lengthens at least one of the first and second sections during next and subsequent driving.

3. The stepping motor control circuit according to claim 1, wherein, when the rotation detecting means has detected an induced signal exceeding the reference threshold voltage in the second section and the at least one of the first and second sections is lengthened, the control means shortens the third section.

4. The stepping motor control circuit according to claim 2, wherein, when the rotation detecting means has detected an induced signal exceeding the reference threshold voltage in the second section and the at least one of the first and second sections is lengthened, the control means shortens the third section.

5. The stepping motor control circuit according to claim 1, wherein, after the rotation detecting means has detected an induced signal exceeding the reference threshold voltage in the second section and a length of a section is changed, when the rotation detecting means has not detected an induced signal exceeding the reference threshold voltage in the second section, the control means allows the section with the changed length to have an original length.

6. The stepping motor control circuit according to claim 2, wherein, after the rotation detecting means has detected an induced signal exceeding the reference threshold voltage in the second section and a length of a section is changed, when the rotation detecting means has not detected an induced signal exceeding the reference threshold voltage in the second section, the control means allows the section with the changed length to have an original length.

7. The stepping motor control circuit according to claim 3, wherein, after the rotation detecting means has detected an induced signal exceeding the reference threshold voltage in the second section and a length of a section is changed, when the rotation detecting means has not detected an induced signal exceeding the reference threshold voltage in the second section, the control means allows the section with the changed length to have an original length.

8. The stepping motor control circuit according to claim 4, wherein, after the rotation detecting means has detected an induced signal exceeding the reference threshold voltage in the second section and a length of a section is changed, when the rotation detecting means has not detected an induced signal exceeding the reference threshold voltage in the second section, the control means allows the section with the changed length to have an original length.

9. An analog electronic watch including a stepping motor for rotating time hands and a stepping motor control circuit for controlling the stepping motor, wherein the stepping motor control circuit according to claim 1 is used as the stepping motor control circuit.

10. An analog electronic watch including a stepping motor for rotating time hands and a stepping motor control circuit for controlling the stepping motor, wherein the stepping motor control circuit according to claim 2 is used as the stepping motor control circuit.

11. An analog electronic watch including a stepping motor for rotating time hands and a stepping motor control circuit for controlling the stepping motor, wherein the stepping motor control circuit according to claim 3 is used as the stepping motor control circuit.

12. An analog electronic watch including a stepping motor for rotating time hands and a stepping motor control circuit for controlling the stepping motor, wherein the stepping motor control circuit according to claim 4 is used as the stepping motor control circuit.

13. An analog electronic watch including a stepping motor for rotating time hands and a stepping motor control circuit for controlling the stepping motor, wherein the stepping motor control circuit according to claim 5 is used as the stepping motor control circuit.

14. An analog electronic watch including a stepping motor for rotating time hands and a stepping motor control circuit for controlling the stepping motor, wherein the stepping motor control circuit according to claim 6 is used as the stepping motor control circuit.

15. An analog electronic watch including a stepping motor for rotating time hands and a stepping motor control circuit for controlling the stepping motor, wherein the stepping motor control circuit according to claim 7 is used as the stepping motor control circuit.

16. An analog electronic watch including a stepping motor for rotating time hands and a stepping motor control circuit for controlling the stepping motor, wherein the stepping motor control circuit according to claim 8 is used as the stepping motor control circuit.
